(19) United States
(12) Patent Application Publication
(10) Pub. No.: US 2026/0284889 A1
(43) Pub. Date: Sep. 24, 2026

(54) SYSTEM AND METHOD FOR MOTION CAPTURE FOR ROBOTIC TELEOPERATION

(71) Applicant: TOYOTA RESEARCH INSTITUTE, INC., Los Altos, CA (US)

(72) Inventors: Eric DUSEL, Cambridge, MA (US); Aditya BHAT, Cambridge, MA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/084,590

(22) Filed: Mar. 19, 2025

(51) Int. Cl. B25J 9/16; G02B 27/01; G06F 3/01

(52) U.S. Cl. CPC B25J 9/1689; G02B 27/017; G06F 3/011; G06F 3/017

(57) ABSTRACT

A method for motion capture for robotic teleoperation is described. The method includes tracking an upper body of a human operator. The method also includes adjusting a pose of limbs and/or joints of a humanoid robot according to the tracking. The method further includes controlling, in response to the human operator, operation of the limbs and/or joints of the humanoid robot. The method also includes providing state information feedback to the operator based on the controlling.

### BACKGROUND

### Field

Certain aspects of the present disclosure relate to machine learning and, more particularly, a system and method for motion capture for robotic teleoperation.

### Background

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

One effective way of generating robotic motion is having the robot mimic the movement of a human, which is referred to as human-robot motion retargeting. Unfortunately, full body motion capture suits involve numerous motion markers located on various body portions of the robot and work in unison to capture and track different body tracking motions, such as wrists, legs, fingers, or the like, to perform human-robot motion retargeting. A teleoperation system that utilizes a particular implementation of retargeting to mimic a particular angle and/or position of the robot, as well as selectively controlling different operational parameters of the robot via a user interface, is desired.

### SUMMARY

A method for motion capture for robotic teleoperation is described. The method includes tracking an upper body of a human operator. The method also includes adjusting a pose of limbs and/or joints of a humanoid robot according to the tracking. The method further includes controlling, in response to the human operator, operation of the limbs and/or joints of the humanoid robot. The method also includes providing state information feedback to the operator based on the controlling.

A non-transitory computer-readable medium having program code recorded thereon for motion capture for robotic teleoperation is described. The program code is executed by a processor. The non-transitory computer-readable medium includes program code to track an upper body of a human operator. The non-transitory computer-readable medium also includes program code to adjust a pose of limbs and/or joints of a humanoid robot according to the tracking. The non-transitory computer-readable medium further includes program code to control, in response to the human operator, operation of the limbs and/or joints of the humanoid robot. Additionally, the non-transitory computer-readable medium includes program code to provide state information feedback to the operator based on the program code to control.

A system for motion capture for robotic teleoperation is described. The system includes a tracking module to track an upper body of a human operator. The system also includes a pose adjustment module to adjust a pose of limbs and/or joints of a humanoid robot according to the tracking. The system further includes a robotic control module to control, in response to the human operator, operation of the limbs and/or joints of the humanoid robot. Additionally, the system includes a robotic feedback module to provide state information feedback to the operator based on the robotic control module.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system and method for motion capture for robotic teleoperation using a system-on-a-chip (SOC) of a robot, in accordance with aspects of the present disclosure.

FIG. 2 is a block diagram illustrating a software architecture for motion capture for robotic teleoperation, according to aspects of the present disclosure.

FIG. 3 is a diagram illustrating an example of a hardware implementation for motion capture for a robotic teleoperation system, according to various aspects of the present disclosure.

FIGS. 4A-4E illustrate an upper body egocentric retargeting (UBER) process, according to various aspects of the present disclosure.

FIGS. 5A and 5B illustrate an upper body limb retargeting, according to various aspects of the present disclosure.

FIG. 6 illustrates a motion retargeting teleoperation process, according to various aspects of the present disclosure.

FIGS. 7A and 7B illustrate an augmented reality (AR) head mounted display (HMD) retargeting application, according to various aspects of the present disclosure.

FIG. 8 illustrates a gesture-based parallel gripper control implementation, according to various aspects of the present disclosure.

FIG. 9 illustrates a systems diagram for a telerobotics stack, according to various aspects of the present disclosure.

FIG. 10 is a flowchart illustrating a method for motion capture for robotic teleoperation, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

One effective way of generating robotic motion is having the robot mimic the movement of a human, which is referred to as human-robot motion retargeting. Unfortunately, full body motion capture suits involve numerous motion markers located on various body portions of the robot and work in unison to capture and track different body tracking motions, such as wrists, legs, fingers, or the like, to perform human-robot motion retargeting. A teleoperation system that utilizes a particular implementation of retargeting to mimic a particular angle and/or position of the robot, as well as selectively controlling different operational parameters of the robot via a user interface, is desired.

Various aspects of the present disclosure are directed to a system and method for motion capture for robotic teleoperation. In some implementations, a robotic teleoperation process tracks an upper body of an operator and adjusts a pose of a pair of limbs and/or joints of a humanoid robot according to the tracking. This robotic teleoperation process enables human operator control of the limbs and/or joints of the humanoid robot, in which state information is fed back to the operator according to the teleoperation. In some implementations, manipulation of a humanoid robot involves an augmented reality (AR) head mounted display (HMD), which shows limbs and/or joints of a humanoid robot currently being controlled and overlays state information of the humanoid robot on the HMD. For example, this displayed information relates to a state of the limbs and/or joints of the humanoid robot as well as controls to manipulate the limbs and/or joints.

Some implementations of the present disclosure are directed to a robotic teleoperation system that is capable of capturing motions of a humanoid robot, including particular poses such as of the arms and elbows of the humanoid robot. Additionally, this implementation utilizes a user interface that provides interactive settings for the humanoid robot. For example, the user interface displays a real-time view from the perspective of the robot and facilitates controlling different operational parameters of the robot. In some implementations, the user interface is implemented using an augmented reality (AR) head mounted display (HMD).

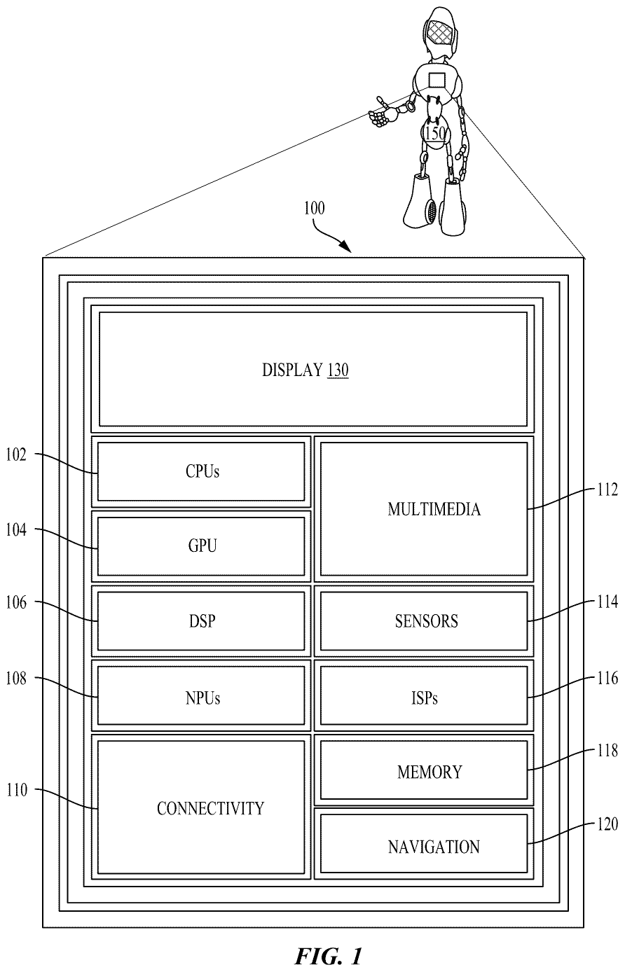

FIG. 1 illustrates an example implementation of a system and method for motion capture for robotic teleoperation using a system-on-a-chip (SOC) 100 of a robot 150, in accordance with aspects of the present disclosure. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) connectivity, sixth generation (6G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of a humanoid robot, according to the display 130 (e.g., an augmented reality (AR) head mounted display (HMD) illustrating a view of the robot 150. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., the CPU 102) or the NPU 108 of the robot 150 may include code for motion capture (e.g., of the robot 150) to enable teleoperation of the robot 150 from images captured by the sensor processor 114 of the robot 150.

The instructions loaded into a processor (e.g., the CPU 102) may also include code to track an upper body of an operator of a humanoid robot. The instructions loaded into a processor (e.g., the CPU 102) may further include code to adjust a pose of a pair of limbs and/or joints of the humanoid robot according to the tracking. The instructions loaded into a processor (e.g., the CPU 102) may also include code to control operation of the limbs and/or joints of the humanoid robot. The instructions loaded into a processor (e.g., the CPU 102) may further include code to feed back robot state information to the operator based on the controlling. In some implementations, manipulation of a humanoid robot involves an augmented reality (AR) head mounted display (HMD), which shows limbs and/or joints of a humanoid robot currently being controlled and overlays state information of the humanoid robot on the HMD. For example, this displayed information relates to a state of the limbs and/or joints of the humanoid robot as well as controls to manipulate the limbs and/or joints.

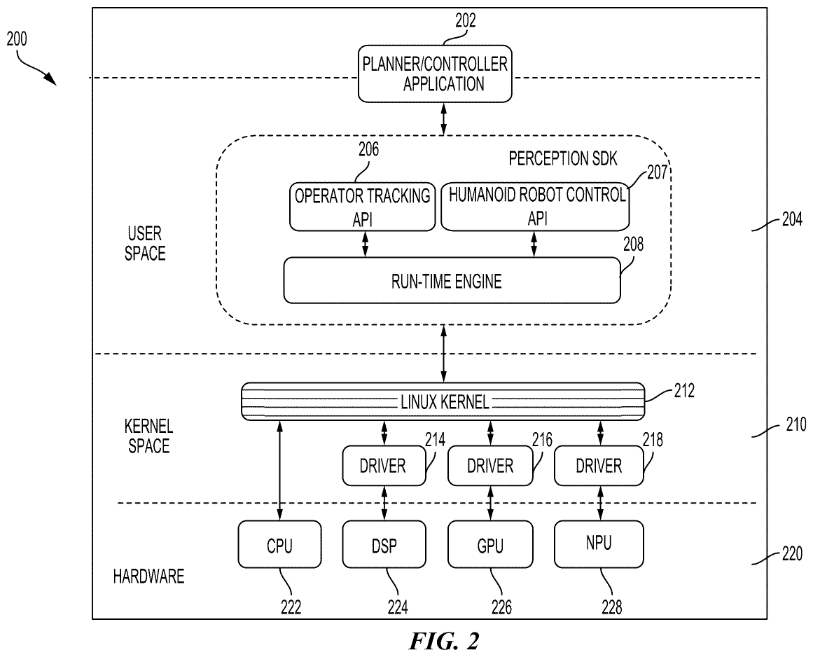

FIG. 2 is a block diagram illustrating a software architecture 200 for motion capture for robotic teleoperation, according to aspects of the present disclosure. Using the software architecture 200, a planner/controller application 202 may be designed such that it may cause various processing blocks of a system-on-a-chip (SOC) 220 (for example a CPU 222, a DSP 224, a GPU 226, and/or an NPU 228) to perform supporting computations during run-time operation of the planner/controller application 202.

The planner/controller application 202 may be configured to call functions defined in a user space 204 that may, for example, provide motion capture for robotic teleoperation. Various aspects of the present disclosure propose manipulation of a humanoid robot utilizing an augmented reality (AR) head mounted display (HMD), illustrating limbs and/or joints of a humanoid robot currently being controlled and overlaying state information of the humanoid robot on the HMD. For example, this displayed information relates to a state of the limbs and/or joints of the humanoid robot as well as displayed controls to manipulate the limbs and/or joints of the humanoid robot.

In various aspects of the present disclosure, the planner/controller application 202 may make a request to compile program code associated with a library defined in an operator tracking application programming interface (API) 206 to track an upper body of an operator of a humanoid robot. The operator tracking API 206 may also adjust a pose of a pair of limbs and/or joints of the humanoid robot according to the tracking. A humanoid robot control API 207 may control operation of the limbs and/or joints of the humanoid robot. Additionally, the humanoid robot control API 207 may feed back robot state information to the operator based on the controlling.

A run-time engine 208, which may be compiled code of a run-time framework, may be further accessible to the planner/controller application 202. The planner/controller application 202 may cause the run-time engine 208, for example, to perform motion capture for robotic teleoperation. When an operation motion capture is performed for teleoperation of the humanoid robot, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

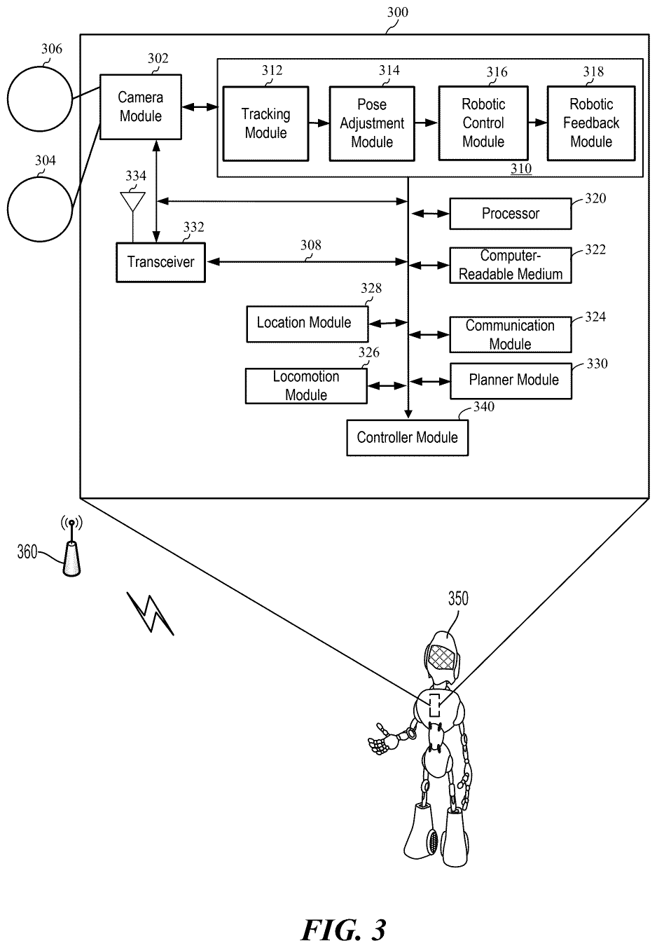

FIG. 3 is a diagram illustrating an example of a hardware implementation of motion capture for a robotic teleoperation system 300, according to various aspects of the present disclosure. The robotic teleoperation system 300 may be configured for operator-based control of a robot 350 in response to images from video captured through a camera during operation of the robot 350. The robotic teleoperation system 300 may be a component of a robotic or other autonomous device. For example, as shown in FIG. 3, the robotic teleoperation system 300 is a component of the robot 350. Aspects of the present disclosure are not limited to the robotic teleoperation system 300 being a component of the robot 350, as other devices, such as an autonomous vehicle, a bus, a motorcycle, or other like autonomous vehicles, are also contemplated for using the robotic teleoperation system 300. The robot 350 may be autonomous or semi-autonomous.

The robotic teleoperation system 300 may be implemented with an interconnected architecture, such as a controller area network (CAN) bus, represented by an interconnect 308. The interconnect 308 may include any number of point-to-point interconnects, buses, and/or bridges depending on the specific application of the robotic teleoperation system 300 and the overall design constraints of the robot 350. The interconnect 308 links together various circuits, including one or more processors and/or hardware modules, represented by a camera module 302, a motion capture module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The robotic teleoperation system 300 includes a transceiver 332 coupled to the camera module 302, the motion capture module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit robotic state information from the motion capture module 310 to a server (not shown).

The robotic teleoperation system 300 includes the processor 320 coupled to the computer-readable medium 322. The processor 320 performs processing, including the execution of software stored on the computer-readable medium 322 to provide motion capture for robotic teleoperation functionality, according to the present disclosure. The software, when executed by the processor 320, causes the robotic teleoperation system 300 to perform the various functions described for robotic teleoperation with a surrounding environment from scenes in video captured by a camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a first camera 304 and a second camera 306. The first camera 304 and the second camera 306 may be a vision sensor (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the sensors, as other types of sensors (e.g., thermal, sonar, and/or lasers) are also contemplated for either of the first camera 304 or the second camera 306.

The images of the first camera 304 and/or the second camera 306 may be processed by the processor 320, the camera module 302, the motion capture module 310, the communication module 324, the locomotion module 326, the location module 328, and the controller module 340. In conjunction with the computer-readable medium 322, the images from the first camera 304 and/or the second camera 306 are processed to implement the functionality described herein. In one configuration, detected 2D object information captured by the first camera 304 and/or the second camera 306 may be transmitted via the transceiver 332. The first camera 304 and the second camera 306 may be coupled to the robot 350 or may be in communication with the robot 350.

The location module 328 may determine a location of the robot 350 using simultaneous localization and mapping (SLAM). Alternatively, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication-Physical layer using microwave at 5.9 GHZ (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the robotic teleoperation system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SM S), multimedia messaging service (M M S), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, 6G, LTE, LTE-V2X, LTE-D2D, VoLTE, or any other mobile data network or combination of mobile data networks. Further, the network access point 360 may include one or more IEEE 802.11 wireless networks.

The robotic teleoperation system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.

Level 0: In a Level 0 agent, the set of advanced driver assistance system (ADAS) features installed in an agent provide no agent control but may issue warnings to the driver of the agent. An agent which is Level 0 is not an autonomous or semi-autonomous agent.

Level 1: In a Level 1 agent, the driver is ready to take operation control of the autonomous agent at any time. The set of ADAS features installed in the autonomous agent may provide autonomous features such as: adaptive cruise control (ACC); parking assistance with automated steering; and lane keeping assistance (LKA) type II, in any combination.

Level 2: In a Level 2 agent, the driver is obliged to detect objects and events in the roadway environment and respond if the set of ADAS features installed in the autonomous agent fail to respond properly (based on the driver's subjective judgement). The set of ADAS features installed in the autonomous agent may include accelerating, braking, and steering. In a Level 2 agent, the set of ADAS features installed in the autonomous agent can deactivate immediately upon takeover by the driver.

Level 3: In a Level 3 ADAS agent, within known, limited environments (such as freeways), the driver can safely turn their attention away from operation tasks but must still be prepared to take control of the autonomous agent when needed.

Level 4: In a Level 4 agent, the set of ADAS features installed in the autonomous agent can control the autonomous agent in all but a few environments, such as severe weather. The driver of the Level 4 agent enables the automated system (which is comprised of the set of ADAS features installed in the agent) only when it is safe to do so. When the automated Level 4 agent is enabled, driver attention is not required for the autonomous agent to operate safely and consistent within accepted norms.

Level 5: In a Level 5 agent, other than setting the destination and starting the system, no human intervention is involved. The automated system can drive to any location where it is legal to drive and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The motion capture module 310 may be in communication with the camera module 302, the processor 320, the computer-readable medium 322, the communication module 324, the locomotion module 326, the location module 328, the planner module 330, the transceiver 332, and the controller module 340. In one configuration, the motion capture module 310 receives sensor data from the camera module 302. The camera module 302 may receive RGB video image data from the first camera 304 and the second camera 306. According to aspects of the present disclosure, the motion capture module 310 may receive RGB video image data directly from the first camera 304 or the second camera 306 as well as an RGB depth (RGB-D) to explore an environment from images captured by the first camera 304 and the second camera 306 of the robot 350. In various aspects of the present disclosure, the planner module 330 and/or the controller module 340 are configured for planning and control of the robot 350 to perform motion capture for teleoperation, as follows.

One effective way of generating robotic motion is having the robot mimic the movement of a human, which is referred to as human-robot motion retargeting. The goal of human-robot motion retargeting is driving a humanoid robot to move in a natural way provided with the joint movements or positions captured from a human. In particular, human-robot motion retargeting enables a robot to follow the movements performed by a human subject. This is traditionally achieved by applying the estimated poses from a human pose tracking system to a robot via explicit joint mapping strategies.

Some implementations provide various operational modes of upper body egocentric retargeting, including forward retargeting, which preserves angles of the limbs based on the position of a controller, and inverse retargeting, which preserves the positions of a pair of end effectors. In robotics, forward retargeting refers to the process of taking motion data captured from a human (or another source) and directly translating it into corresponding movements for a robot, essentially mapping human poses and motions onto a robot's joint space. Forward retargeting allows the robot to mimic those actions captured from a human operator despite having a different physical structure. Forward retargeting enables human-robot interaction and motion imitation where the goal is to transfer human movements to a robot in real-time. Inputs for these targeting schemes either may be input directly or may be tracked from various sources, such as cameras, depth cameras, wearable devices, and the like before control is initiated.

As shown in FIG. 3, the motion capture module 310 includes a tracking module 312, a pose adjustment module 314, a robotic control module 316, and a robotic feedback module 318. The tracking module 312, the pose adjustment module 314, the robotic control module 316, and the robotic feedback module 318 may be components of a same or different artificial neural network, such as a convolutional neural network (CNN). The modules (e.g., 312, 314, 316, 318) of the motion capture module 310 are not limited to a CNN. In operation, the motion capture module 310 receives a video stream from the first camera 304 and the second camera 306. The video stream may include a two-dimensional red-green-blue (2D RGB) left image from the first camera 304 and a 2D RGB right image from the second camera 306 to provide video frame images. The video stream may include multiple frames, such as image frames.

In some aspects of the present disclosure, the motion capture module 310 is configured for robotic teleoperation of the robot 350. The motion capture module 310 includes the tracking module 312 to track an upper body of an operator of a humanoid robot. Additionally, the motion capture module 310 includes the pose adjustment module 314 to adjust a pose of a pair of limbs and/or joints of the humanoid robot according to the tracking. For example, tracking of the operator using the tracking module 312 enables upper body egocentric retargeting, including forward retargeting, which preserves angles of the limbs of the robot 350 based on the position of the operator, and inverse retargeting, which preserves the positions of the end effectors.

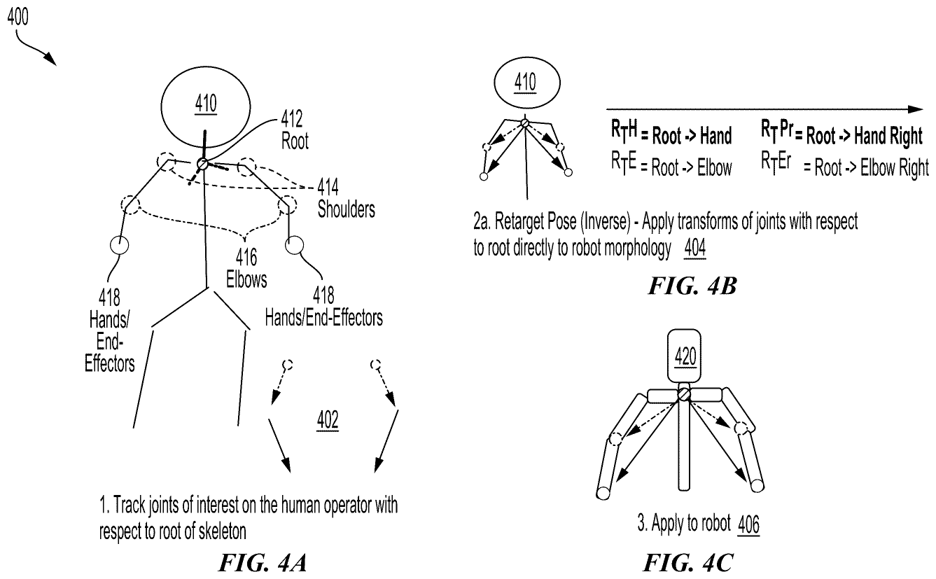

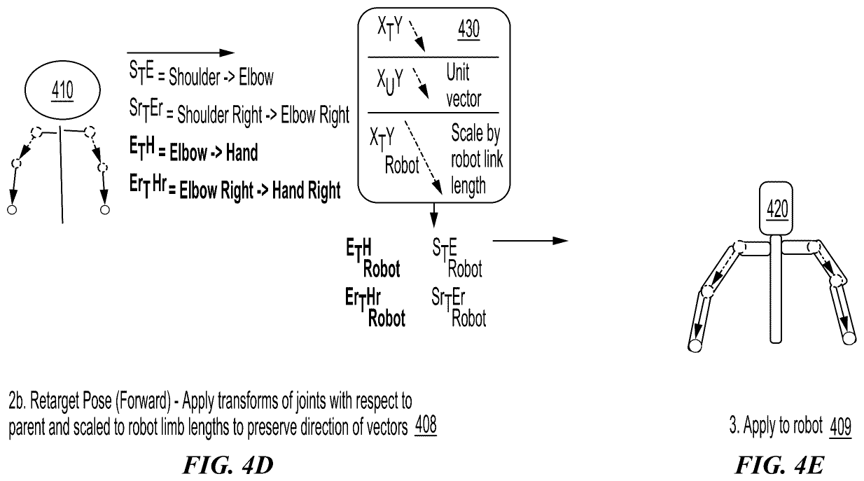

In this example, the motion capture module 310 includes the robotic control module 316 to control operation of the limbs and/or joints of the robot 350. Additionally, the motion capture module 310 includes the robotic feedback module 318 to feed back state information of the robot 350 to the operator based on the controlling. In some implementations, manipulation of the robot 350 is performed using an augmented reality (AR) head mounted display (HMD), which shows limbs and/or joints of a humanoid robot currently being controlled and overlays state information of the humanoid robot on the HMD using the robotic feedback module 318. For example, this displayed information relates to a state of the limbs and/or joints of the robot 350 as well as controls to manipulate the limbs and/or joints of the robot 350, for example, as shown in FIGS. 4A-4E.

FIGS. 4A-4E illustrate an upper body egocentric retargeting (UBER) process, according to various aspects of the present disclosure. FIGS. 4A-4E illustrate various operational modes of an UBER process 400, including forward retargeting (see FIGS. 4D and 4E), which preserves angles of the limbs based on the position of a human operator (relative to a root 412 of a skeleton 410), and inverse retargeting (see FIGS. 4B and 4C), which preserves the positions of end-effectors 418 (e.g., hands) relative to the root 412 of the skeleton 410, as shown in FIG. 4A.

As shown in FIGS. 4D and 4E, forward retargeting refers to the process of taking motion data captured from the human operator with respect to the root 412 of the skeleton 410 and directly translating the motion data into corresponding movements for a robot 420. For example, as shown in FIG. 4A, corresponding portions of the human operator are monitored for motion data relative to the root 412 of the skeleton 410. These corresponding portions include shoulders 414, elbows 416, and the pair of end-effectors 418 (e.g., hands) of the skeleton 410.

As shown in FIG. 4C, various aspects of the present disclosure include tracking points of interest of a robot 420, such as tracking a set of joints relative to the root 412 of the skeleton 410. These points may be located on, for example, the shoulders 414, the elbows 416, the end-effectors 418 (e.g., hands), or the like. Prior to applying transforms of the set of joints to the robot 420, one of two retargeting implementations may be carried out during robotic teleoperation according to the UBER process 400.

For example, FIGS. 4B and 4C illustrate a first retargeting implementation, referred to as a retarget pose inverse implementation. In some implementations, retarget pose inverse implementation determines transformations of the set of joints with respect to the root 412 of the skeleton 410, which are subsequently applied to the robot 420. For example, as shown in FIG. 4A, certain points of interest of the operator relative to the root 412 of the skeleton 410 are taken, such as elbows 416 with respect to an origin point (e.g., the root 412), which also considers a distance from one end of the end-effectors 418 (e.g., hands) of the skeleton 410. The retarget pose inverse implementation applies the following transforms of joints with respect to the root 412 of the skeleton 410 directly to a morphology of the robot 420:

$${}^{R} {T}^{HL} = Root \to Hand Left \qquad ( 1 )$$

$${}^{R} {T}^{EL} = Root \to Elbow Left \qquad ( 2 )$$

$${}^{R} {T}^{Hr} = Root \to Hand Right \qquad ( 3 )$$

$${}^{R} {T}^{Er} = Root \to Elbow Right \qquad ( 4 )$$

Additionally, FIGS. 4D and 4E illustrate a second retarget implementation, referred to as a retarget pose forward implementation. In some implementations, a retarget pose forward implementation performs isolation of certain points of interest of the robot (e.g., angles that an arm is making). This is in contrast to the inverse implementation, which instead tracks poses of the robot 420 in a given space. Under the forward implementation, transforms of joints may be determined and scaled to robot limb lengths to preserve a direction of vectors as follows:

$${}^{S} {T}^{El} = Shoulder \to Elbow Left \qquad ( 5 )$$

$${}^{S} {T}^{Er} = Shoulder Right \to Elbow Right \qquad ( 6 )$$

$${}^{E} {T}^{Hl} = Elbow Left \to Hand Left \qquad ( 7 )$$

$${}^{Er} {T}^{Hr} = Elbow Right \to Hand Right \qquad ( 8 )$$

$${}^{E} {T}_{Robot}^{H} {}^{S} {T}_{Robot}^{E} \qquad ( 9 )$$

$${}^{Er} {T}_{Robot}^{Hr} {}^{Sr} {T}_{Robot}^{Er} \qquad ( 10 )$$

As shown in block 430, the retarget pose forward implementation transformations from Equations (5)-(8) of the joint with respect to the root 412 of the skeleton 410 are scaled (using Equations (9) and (10)) to limb lengths of the robot 420 to preserve a direction of the vectors. In certain implementations, a teleoperation system implementing the UBER process 400 is scalable to other points of interest of the robot 420 besides an upper body, such as legs and/or waist.

Length of robot limb (for example, from shoulder to elbow)=L. Position of human joint (for example, elbow)=J(xⱼ,yⱼ,zⱼ). Position of parent joint (for example, the shoulder is the parent of the elbow)=P(xₚ,yₚ,zₚ). Vector from parent to joint=V(x,y,z).

$$V = J - P = ( {x}_{j} - {x}_{p} , {y}_{j} - {y}_{p} - {z}_{p} ) = ( x , y , z )$$

When you have V, you can normalize it by dividing each component by the magnitude of the vector (also known as the distance between the two points). Distance between P and J=D.

$$D = sqrt ( {x}^{2} + {y}^{2} + {z}^{2} )$$

This normalized vector is known as the unit vector, U(xᵤ,yᵤ,zᵤ), which isolates the direction of the vector and reduces the magnitude to 1.

$$U = ( {x}_{D} , {y}_{D} , {z}_{D} ) = ( {x}_{u} , {y}_{u} , {z}_{u} )$$

To find the final point of the elbow, scaling can be applied to this unit vector based on the length of this limb on the robot target.

Robot position of joint (for example, robot's elbow)=R(xᵣ,yᵣ,zᵣ).

$$R = ( {x}_{u \times L} , {y}_{u \times L} , {z}_{u \times L} ) = ( {x}_{r} , {y}_{r} , {z}_{r} )$$

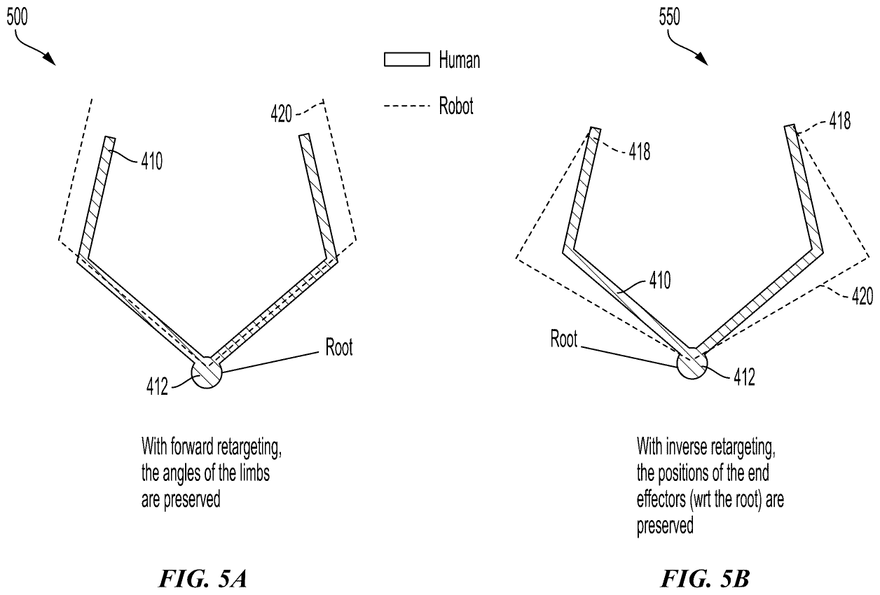

FIGS. 5A and 5B further illustrate the inverse retargeting and forward retargeting implementations shown in FIGS. 4A-4E, according to various aspects of the present disclosure.

FIGS. 5A and 5B illustrate an upper body limb retargeting according to various operational modes of the UBER process 400 of FIGS. 4A-4E, according to various aspects of the present disclosure. In particular, FIG. 5A further illustrates forward retargeting (see FIGS. 4A and 4B), which preserves angles of the limbs based on the position of a human operator (relative to a root 412 of the skeleton 410). Additionally, FIG. 5B illustrates the inverse retargeting implementation (see FIGS. 4B and 4C), which preserves the positions of the end-effectors 418 (e.g., hands) of the skeleton 410, according to various aspects of the present disclosure.

FIG. 5A illustrates a forward retargeting implementation 500, in which the angles of the limbs of the human operator and the robot 420 are preserved relative to the root 412 of the skeleton 410. Tracking joints of interest on the human operator with respect to the root 412 of the skeleton 410 is essentially mapping human poses and motions onto the joint space of the robot 420. In this example, forward retargeting implementation 500 allows the robot 420 to mimic the actions captured from a human operator despite having a different physical structure. In particular, the forward retargeting implementation 500 enables human-robot interaction and motion imitation, in which the goal is to transfer human movements to the robot 420 in real-time.

FIG. 5B illustrates an inverse retargeting implementation 550, in which the positions of the end-effectors 418 are preserved relative to the root 412. In some implementations, the inverse retargeting implementation 550 determines transformations of the set of joints with respect to the root 412 of the skeleton 410, which are subsequently applied to the robot 420. For example, as shown in FIG. 4A, certain points of interest of the operator relative to the root 412 of the skeleton 410 are taken, such as elbows 416 with respect to an origin point (e.g., the root 412), which also considers a distance from one end of the end-effectors 418 (e.g., the hands) of the skeleton 410.

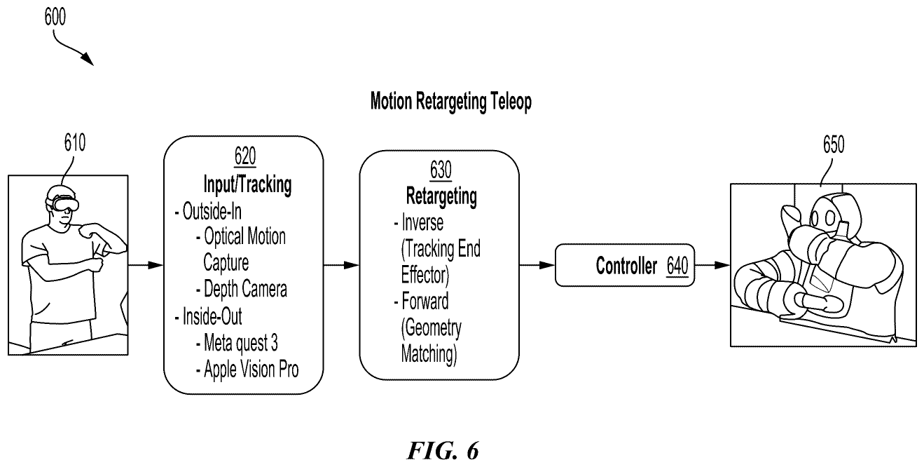

FIG. 6 illustrates a motion retargeting teleoperation process 600, according to various aspects of the present disclosure. In this example, an input/tracking block 620 monitors a human operator 610. The input/tracking block 620 may directly receive input data or the input/tracking block 620 may track the human operator 610 from various sources, such as cameras, depth cameras, wearable devices, and the like before control is initiated. As further illustrated in FIG. 6, a retargeting block 630 may perform the inverse or forward targeting schemes shown in FIGS. 5A and 5B. Based on the selected scheme, instructions are provided to a controller 640 to control the humanoid robot 650.

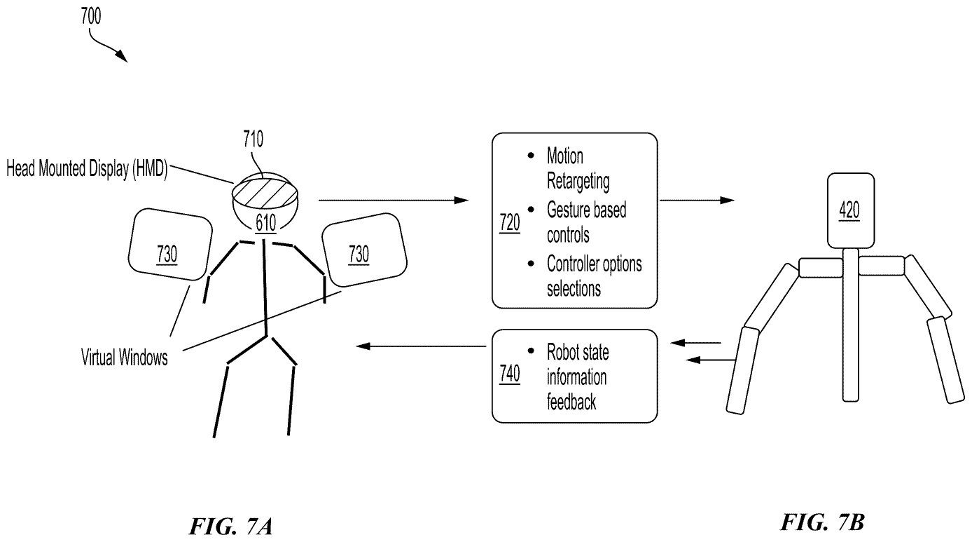

In some implementations, the input/tracking block 620 utilizes motion capture to track an upper body of the human operator 610, such as outside-in tracking using optical motion capture and/or a depth camera. For example, as shown in FIG. 4A, six points of interest (e.g., 2× shoulders 414, 2× elbows 416, 2× end-effectors 418 e.g., wrists/hands) are used to calculate a suitable pose for the arms of the humanoid robot 650. Further, a virtual reality application and a user interface enable the human operator 610 to track the six points of interest (e.g., using on-board inside-out tracking of the input/tracking block 620) as a selected number of controlled joints. Additionally, the virtual reality application and a user interface provided a menu where the operator can control various motions, particularly but not limited to elbow tracking, of the robot 420 as well as pausing the robot 420, for example, as shown in FIGS. 7A and 7B.

FIGS. 7A and 7B illustrate an augmented reality (AR) head mounted display (HMD) retargeting application 700, according to various aspects of the present disclosure. As shown in FIG. 7A, a user interface 720 is displayed on a screen of an AR HMD 710. In this example, the user interface 720 includes applications for motion retargeting, gesture-based controls, and options for selecting various control portions of the robot 420. Additionally, virtual windows 730 may be used in the AR HMD 710 to modify parameter settings, such as a particular retargeting mode, robotic speed, or the like, and robot state information feedback 740 may be displayed in the virtual windows.

As shown in FIGS. 7A and 7B, control feedback (e.g., robot state information feedback 740) is further provided through the user interface 720, preferably the AR HMD 710. In this example, the AR HMD 710 displays the virtual windows 730, which are used to adjust operating parameters of the robot 420. For example, the virtual windows 730 enable the human operator 610 to choose how many joints are controlled for operation, set a mimicry speed, view real-time feeds relating to the operation of the robot 420, view feeds from the perspective of the robot 420, and the like. Additionally, these views may be superimposed on the robot in view of the AR display device to improve correlation between the settings and the robot.

In some implementations, the human operator 610 retargeting of a pose of the robot 420 is performed by utilizing inside-out body tracking capabilities of the AR HMD 710. Additionally, the human operator 610 uses the virtual windows 730 to modify various controlling settings, such as retargeting mode, speed, etc., of the robot 420. The human operator 610 may view the robot state information feedback 740 in the virtual windows 730. By way of example, via a customized menu of the user interface 720, a number of joints of the robot 420 may be controlled for operation, a speed of mimic may be controlled, and display of a real-time feed from the perspective of the robot 420 may be selectively displayed.

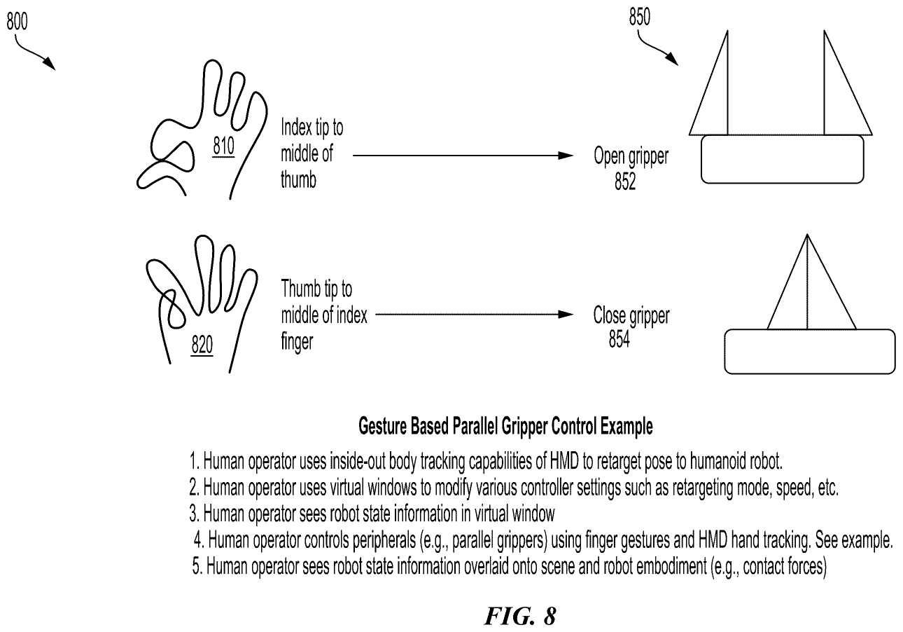

FIG. 8 illustrates a gesture-based parallel gripper control implementation, according to various aspects of the present disclosure. By way of example, a parallel gripper 850 is operated using hand gestures 800 (e.g., finger gestures), such that an index tip to a middle of thumb hand gesture 810 may be indicative of controlling the parallel gripper 850 to an open gripper position 852. Conversely, a thumb tip to a middle of the index finger hand gesture 820 may be indicative of controlling the parallel gripper 850 to a closed position 854. In this example, a human operator (e.g., the skeleton 410) controls peripherals of the robot 420 (e.g., the parallel grippers 850 using the hand gestures 800). As shown in FIGS. 7A and 7B, the AR HMD 710 utilizes tracking through the user interface 720 to operate the peripherals of the robot 420. Additionally, the human operator sees robot state information feedback 740 overlaid onto a scene and robot implementation (e.g., contact forces).

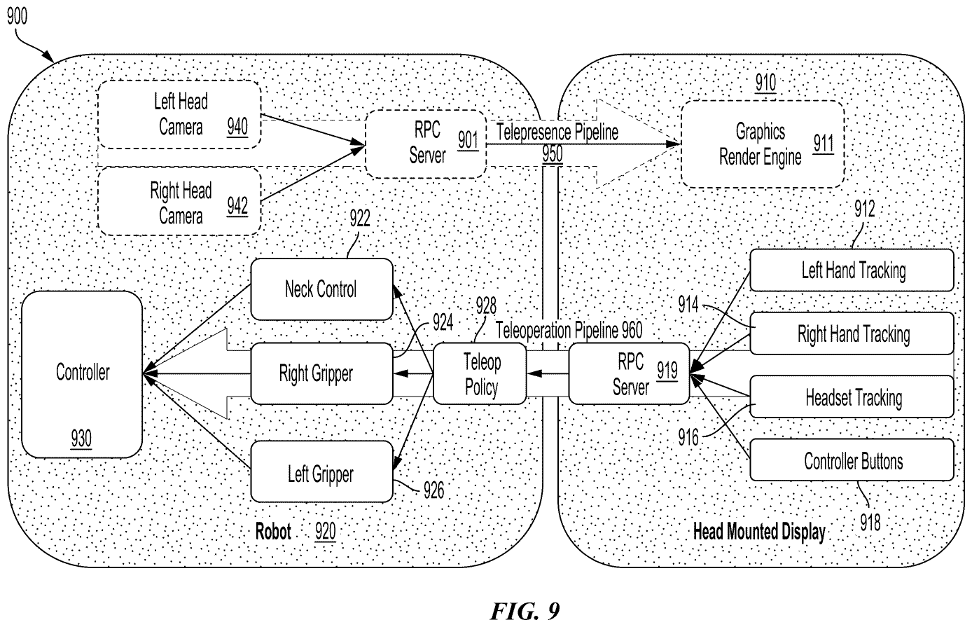

FIG. 9 illustrates a systems diagram for a telerobotics stack 900, according to various aspects of the present disclosure. As shown in FIG. 9, the telerobotics stack 900 provides a combination of both teleoperation (e.g., controlling the robot 920) and telepresence, which refers to the immersive interface that allows the operator to feel present in the remote environment. This is where the stereo feed back to the user in the HMD 910 allows user to see through the eyes of the robot 920.

In some implementations, a feed from the robot 920 is provided as a video feed to operators wearing the HMD 910 from a left head camera 940 and a right head camera 942 utilizing a remote procedure call (RPC) server 901 according to a telepresence pipeline 950. The telepresence pipeline 950 is received by a graphics render engine 911 as a stereo fee based on the left head camera 940 and a right head camera 942. In this implementation, the HMD 910 enables left hand tracking 912, right hand tracking 914, headset tracking 916, and controller buttons 918, which are communicated to the robot 920 through an RPC server 919 to a teleop policy 928 as part of a teleoperations pipeline 960. In this implementations, the controller buttons 918 of handheld controllers are utilized in conjunction with a virtual interface and gestures for the operator to have more options when selecting various control modes or parameters of the robot 920.

According to various aspects of the present disclosure, aside from controlling the upper body limbs (notably left and right arms) of the robot 920, the robot 920 supports a neck control 922 for controlling both the gaze (direction of head mounted cameras on a neck with two DOFs for pan and tilt) using the headset tracking capabilities of the HMD 910. Additionally, the right gripper 924 and the left griper 926 enable pose and state control as well as control the torso with this same tracking to help the robot 920 bend forward.

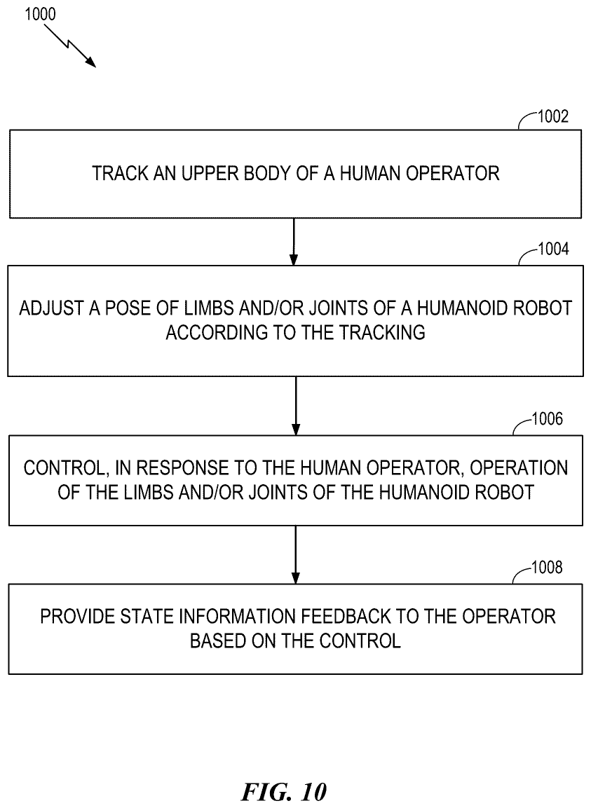

As shown in FIG. 9, the controller 930 may utilize various techniques for determining robot joint positions (e.g., a value corresponding to the rotation of the joint) based on the positions given from the retargeting. For example, differential inverse kinematics may be utilized for computing the value corresponding to the rotation of the joint to determine the joint robot position based on the positions given from retargeting. Inverse kinematics provide an approach for solving a joint position based on a pose in operational space in robotics applications. Additionally, the controller 930 of the robot 920 may be implemented using an operation space controller for solving the joint position in an operational space. A process of motion control for robotic teleoperation is illustrated, for example, in FIG. 10.

FIG. 10 is a flowchart illustrating a method 1000 for motion capture for robotic teleoperation, according to aspects of the present disclosure. The method 1000 begins at block 1002, in which an upper body of a human operator is tracked. At block 1002, a pose of limbs and/or joints of a humanoid robot are adjusted according to the tracking. For example, as shown in FIGS. 7A and 7B, the human operator 610 retargeting of a pose of the robot 420 is performed by utilizing inside-out body tracking capabilities of the AR HMD 710. Additionally, the human operator 610 uses the virtual windows 730 to modify various controlling settings, such as retargeting mode, speed, etc., of the robot 420.

At block 1006 operation of the limbs and/or joints of the humanoid robot is controlled in response to the human operator. At block 1008 state information feedback is provided to the operator based on the control. For example, as shown in FIGS. 7A and 7B, the human operator 610 may view the robot state information feedback 740 in the virtual windows 730. By way of example, via a customized menu of the user interface 720, a number of joints of the robot 420 may be controlled for operation, a speed of mimic may be controlled, and display of a real-time feed from the perspective of the robot 420 may be selectively displayed.

In some aspects of the present disclosure, the method 1000 may be performed by the SOC 100 (FIG. 1) or the software architecture 200 (FIG. 2) of the robot 150 (FIG. 1). That is, each of the elements of method 1000 may, for example, but without limitation, be performed by the SOC 100, the software architecture 200, or the processor (e.g., CPU 102) and/or other components included therein of the robot 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for motion capture for robotic teleoperation, the method comprising:
tracking an upper body of a human operator;
adjusting a pose of limbs and/or joints of a humanoid robot according to the tracking;
controlling, in response to the human operator, operation of the limbs and/or joints of the humanoid robot; and
providing state information feedback to the operator based on the controlling.

2. The method of claim 1, in which providing the state information feedback comprises displaying, through a user interface of an augmented reality (AR) display device, control feedback through virtual windows to adjust operating parameters of the humanoid robot.

3. The method of claim 2, in which the operating parameters comprise a selected number of controlled joints of the humanoid robot, a mimicry speed setting, a retargeting mode, and/or a robotic speed.

4. The method of claim 2, in which the AR display device comprises an AR head mounted display (HMD).

5. The method of claim 1, in which tracking comprises utilizing inside-out body tracking capabilities of a head mounted display (HMD) to retarget a pose of the humanoid robot.

6. The method of claim 1, in which controlling comprises controlling a pair of end effectors of the humanoid robot using finger gestures.

7. The method of claim 6, in which the pair of end effectors of the humanoid robot comprises parallel grippers.

8. The method of claim 1, in which adjusting a pose comprises upper body egocentric retargeting, including forward retargeting to preserve angles of the limbs based on a position of a controller, and inverse retargeting to preserve the position of a pair of end effectors of the humanoid robot.

9. A non-transitory computer-readable medium having program code recorded thereon for motion capture for robotic teleoperation, the program code being executed by a processor and comprising:
program code to track an upper body of a human operator;
program code to adjust a pose of limbs and/or joints of a humanoid robot according to the tracking;
program code to control, in response to the human operator, operation of the limbs and/or joints of the humanoid robot; and
program code to provide state information feedback to the operator based on the program code to control.

10. The non-transitory computer-readable medium of claim 9, in which the program code to provide the state information feedback comprises program code to display, through a user interface of an augmented reality (AR) display device, control feedback through virtual windows to adjust operating parameters of the humanoid robot.

11. The non-transitory computer-readable medium of claim 10, in which the operating parameters comprise a selected number of controlled joints of the humanoid robot, a mimicry speed setting, a retargeting mode, and/or a robotic speed.

12. The non-transitory computer-readable medium of claim 10, in which the AR display device comprises an AR head mounted display (HMD).

13. The non-transitory computer-readable medium of claim 9, in which the program code to track comprises program code to utilize inside-out body tracking capabilities of a head mounted display (HMD) to retarget a pose of the humanoid robot.

14. The non-transitory computer-readable medium of claim 9, in which the program code to control comprises program code to control a pair of end effectors of the humanoid robot using finger gestures.

15. The non-transitory computer-readable medium of claim 14, in which the pair of end effectors of the humanoid robot comprises parallel grippers.

16. The non-transitory computer-readable medium of claim 9, in which the program code to adjust a pose comprises program code to upper body egocentric retarget, including forward retargeting to preserve angles of the limbs based on a position of a controller, and program code to inverse retarget to preserve the position of a pair of end effectors of the humanoid robot.

17. A system for motion capture for robotic teleoperation, the system comprising:
a tracking module to track an upper body of a human operator;
a pose adjustment module to adjust a pose of limbs and/or joints of a humanoid robot according to the tracking;
a robotic control module to control, in response to the human operator, operation of the limbs and/or joints of the humanoid robot; and
a robotic feedback module to provide state information feedback to the operator based on the robotic control module.

18. The system of claim 17, further comprising comprises an augmented reality (AR) display device, through a user interface of the AR display device, control feedback through virtual windows to adjust operating parameters of the humanoid robot.

19. The system of claim 18, in which the AR display device comprises an AR head mounted display (HMD).

20. The system of claim 17, further comprising a pair of end effectors of the humanoid robot operable using finger gestures.
